(19) United States
(12) Patent Application Publication
(10) Pub. No.: US 2003/0196320 A1
(43) Pub. Date: Oct. 23, 2003

(54) Wire terminal apparatus for electrical connectors

(76) Inventors: Yuji Ikeda, Kanagawa (JP); Kiyomi Maruyama, Kanagawa (JP); Minoru Abe, Kawasaki (JP)

Correspondence Address: JoAnn Dilloway, Barley, Snyder, 126 East King Street, Lancaster, PA, 17602-2893, US

(21) Appl. No.: 10/417,664

(22) Filed: Apr. 17, 2003

(30) Foreign Application Priority Data
Apr. 17, 2002 (JP) 2002-114775

(51) Int. Cl. B23P 19/00

(52) U.S. Cl. 29/749; 29/755

(57) ABSTRACT

A wire terminal apparatus has a wire aligning portion, a wire discriminating portion, and a control portion. The wire aligning portion has wires randomly arranged at a contact arrangement pitch of an electrical connector placed on an adjacent connector placement portion. The wire discriminating portion discriminates the wires arranged in the wire aligning portion. The control portion distinguishes which contacts in the electrical connector are to be mated to each of the wires based on discrimination results obtained by the wire discriminating portion. The control portion sequentially aligns the connector placement portion and the wire aligning portion so that the wires discriminated by the wire discriminating portion can be aligned for connection to the contacts corresponding thereto.

### FIELD OF THE INVENTION

The invention relates to a terminal apparatus for electrical connectors and, more particularly, to a terminal apparatus that discriminates and connects wires to electrical connectors.

### DESCRIPTION OF THE RELATED ART

Connecting a plurality of wires, such as, a plurality of wires that are exposed at one end of a multiconductor cable, to contacts of an electrical connector is commonly performed by a terminal apparatus. The terminal apparatus confirms which wires are to be connected to which contacts before connection so the relationship between the individual wires and the contacts to be connected is made clear.

An example of a color discriminating alignment apparatus is disclosed in Japanese Patent Publication No. Hei 6 (1994)-48885. This color discriminating alignment apparatus is structured so that a color detecting sensor positioned in a vicinity of a wire detects the color of a first wire of a plurality of wires of a multiconductor cable as a clamp grips the wire. An aligning jig having a plurality of linear grooves that is linked to a detecting sensor, is moved so that the clamp is aligned with a predetermined linear groove. The wire held by the clamp is pulled taut and inserted into the predetermined linear groove. A second wire and subsequent wires are then conveyed by the clamp to their corresponding linear grooves one by one by repeating this process.

In another example of a terminal apparatus for electrical connectors disclosed in Japanese Unexamined Patent Publication No. Hei 5 (1993)-144536, the terminal apparatus has a wire core discriminating portion for electrically discriminating each of a plurality of wires of a multiconductor cable. A discoid sensor cuts an outer covering of a plurality of wires to contact conductors thereof. The discoid sensor sends a signal obtained by contacting the conductor of the wire to the wire core discriminating portion, where a determination is made as to which contact the wire is to be connected. A wire core conveying portion conveys the discriminated wire cores to a predetermined contact of an electrical connector that has been placed in a connector placement portion by a chuck of the wire core conveying portion and a connection is made by a connecting portion. This process is repeated for each wire one by one until connections of all the wires is complete.

In the previous examples, the wires are discriminated, clamped, conveyed, and connected one by one such that each operation is performed as many times as there are wires. As a result, the operation efficiency of the above-described terminal apparatuses is extremely poor. It is, therefore, desirable to provide a terminal apparatus for electrical connectors that is capable of performing an efficient discrimination and connection operation.

### SUMMARY OF THE INVENTION

The invention relates to a wire terminal apparatus that has a wire aligning portion, a wire discriminating portion, and a control portion. The wire aligning portion has wires randomly arranged at a contact arrangement pitch of an electrical connector placed on an adjacent connector placement portion. The wire discriminating portion discriminates the wires arranged in the wire aligning portion. The control portion distinguishes which contacts in the electrical connector are to be mated to each of the wires based on discrimination results obtained by the wire discriminating portion. The control portion sequentially aligns the connector placement portion and the wire aligning portion so that the wires discriminated by the wire discriminating portion can be aligned for connection to the contacts corresponding thereto.

### BRIEF DESCRIPTION OF THE DRAWINGS

FIG. 1 is a perspective view of a terminal apparatus for electrical connectors.

FIG. 2 is a perspective view of a connector placement portion and a wire aligning portion of the terminal apparatus.

FIG. 3 is a perspective view of the terminal apparatus during a connecting operation.

FIG. 4 is a perspective view of the terminal apparatus during a step of discriminating wires.

FIG. 5 is a perspective view of the terminal apparatus immediately prior to insulation displacement.

FIG. 6 is a perspective schematic view of contacts and a connector.

### DESCRIPTION OF THE PREFERRED EMBODIMENTS

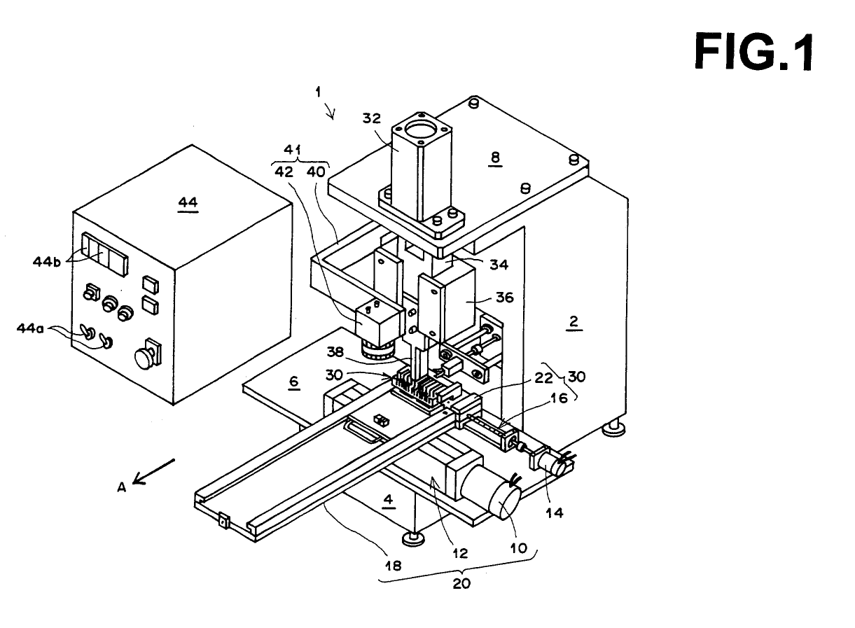

FIG. 1 shows a terminal apparatus for electrical connectors 1. The terminal apparatus 1 includes a main body 2 and a controller 44. It should be noted that in FIG. 1, the direction indicated by the arrow is the direction towards an operator of the terminal apparatus 1 and is referred to as the front, and the opposite direction is referred to as the rear.

As shown in FIG. 1, the main body 2 is provided with a base 4 on a front surface thereof. A work table 6 is mounted atop the base 4. A plate-form ram support portion 8 is mounted on an upper portion of the main body 2. A connector placement portion 20 is provided at a front portion of the work table 6. The connector placement portion 20 has a first slide mechanism 12 and a guide plate 18. The first slide mechanism 12 is driven by a first stepping motor 10. The guide plate 18 is placed so as to intersect with the first slide mechanism 12. The guide plate 18 is mounted so as to be laterally movable on the first slide mechanism 12, which is referred to as a “single axis robot”. The guide plate 18 is secured to a laterally moving body (not shown) of the slide mechanism 12 by a fastening means, such as bolts. A wire aligning portion 30 is provided at a rear of the connector placement portion 20. The wire aligning portion 30 aligns a plurality of wires at a contact arrangement pitch of a connector and in a desired order. The wire aligning portion 30 has a second slide mechanism 16 driven by a second stepping motor 14 and a support base 22 laterally movable by the second slide mechanism 16.

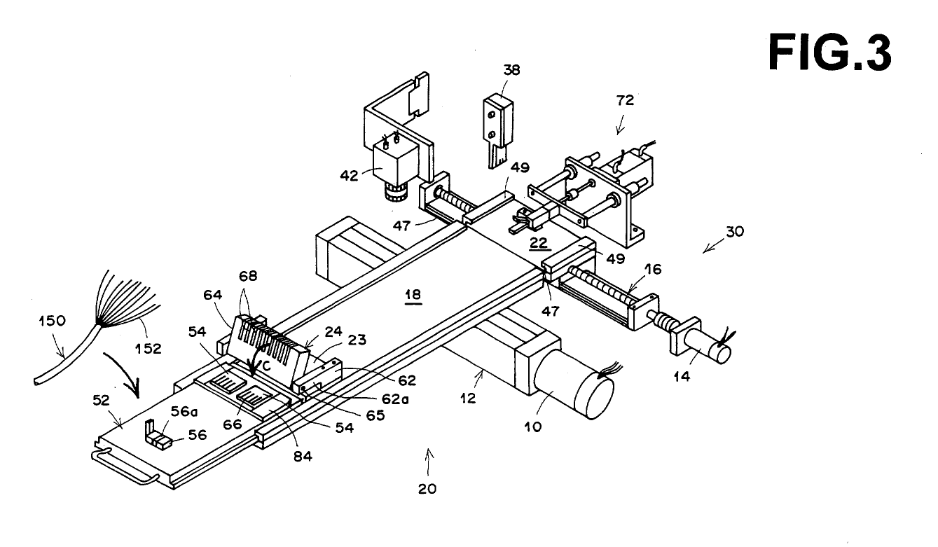

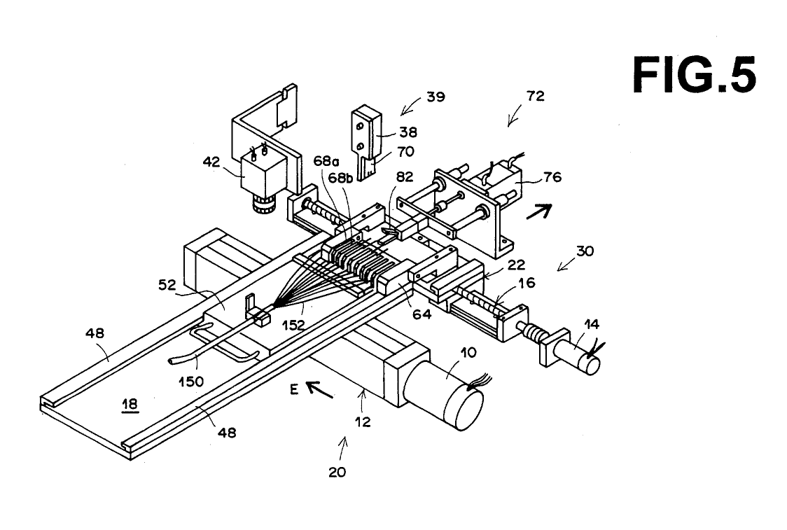

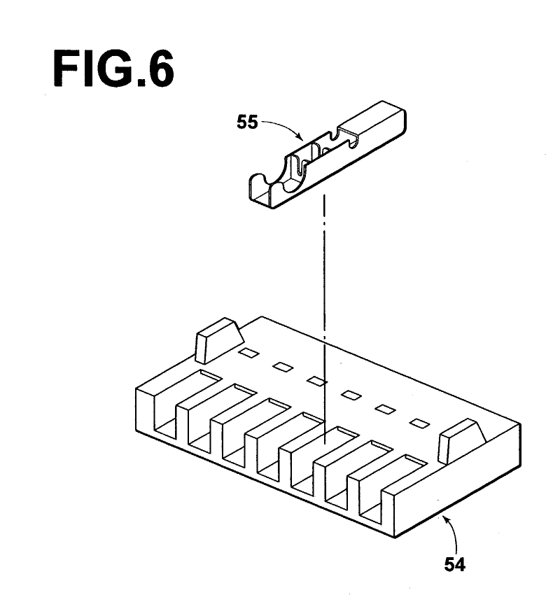

An air cylinder 32 is mounted on a front portion of the ram support portion 8 and vertically moves a ram 34. A housing 36 that guides the ram 34 during the sliding movement thereof is mounted on the main body 2. The ram 34 is substantially rectangular in cross-section, and the housing 36 is structured so as to guide the ram 34 by surrounding the outer portion thereof. A stuffer 38 for connecting wires 152 (FIG. 3) is mounted on a lower end of the ram 34. An insulation displacement blade 70 (FIG. 5), for pressing a wire 152 against a contact 55 (FIG. 6) within a connector 54 (FIG. 6) to establish an insulation displacement connection therebetween, is provided at a lower end of the stuffer 38. The structures for connecting the wires 152, including the air cylinder 32, the ram 34, and the stuffer 38, are collectively referred to as a connecting portion 39 (FIG. 5).

A wire discriminating portion 41 has a downward facing color discriminating camera 42 mounted on the main body 2 via a bracket 40, so that the camera 42 faces the guide plate 18. The controller 44 is provided separate from the main body 2. A central processing unit (CPU) (not shown) is provided in the controller 44, and is connected via wires (not shown) to various components such as the first stepping motor 10, the second stepping motor 14, the camera 42 and the air cylinder 32, to control or communicate therewith. A monitor (not shown) for displaying images of the wires 152 obtained by the camera 42, and a color discrimination processing section (not shown) are provided in a vicinity of the controller 44. Favorable systems that may be used as the wire discriminating portion 41 that include the camera 42, the monitor (not shown), and the color discrimination processing section (not shown) are, for example, CV-700 by KEYENCE, IV-C35M by SHARP, and the like. The controller 44 is provided with various switches 44a for setting the discriminating operation, the connecting operation, etc, and a display portion 44b.

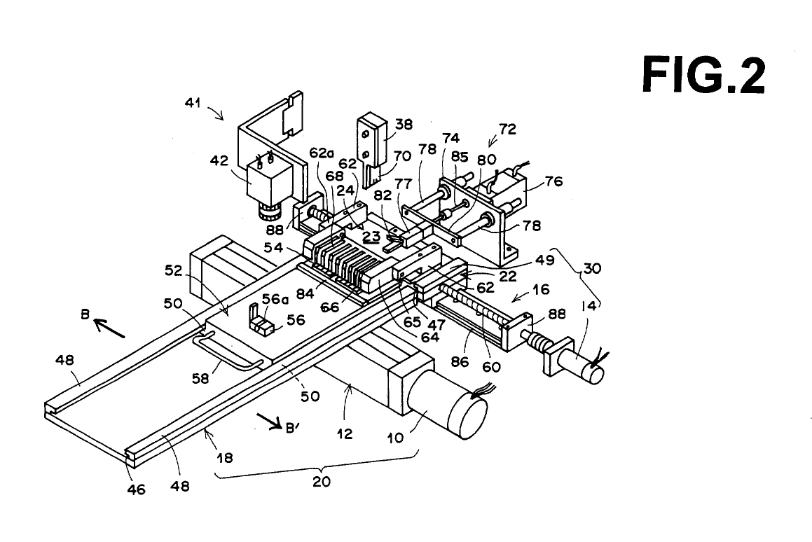

The connector placement portion 20 and the wire aligning portion 30 will now be described in greater detail with reference to FIG. 2. As shown in FIG. 2, the guide plate 18 of the connector placement portion 20 is linked to the first slide mechanism 12 such that by rotation and reverse rotation of the first stepping motor 10, the guide plate 18 is driven to move in a lateral direction indicated by arrows B and B′. The guide plate 18 is a plate-shaped member that extends in a front to rear direction. Guide rails 48, 48 having opposed guide grooves 46 are provided along a longitudinal direction of the guide plate 18 on both lateral sides thereof.

A sliding table 52, provided with ridges 50, 50 that engage the guide grooves 46, is provided on the guide plate 18 so as to be slidable in the front to rear direction while being guided by the guide rails 48, 48. A connector placement plate 84 for positioning the connector 54 is mounted at a rear end of the sliding table 52. The connector 54 is to be placed on the connector placement plate 84. A cable clamp 56 having a cable holding groove 56a is provided at a front end of the sliding table 52. A handle 58 is provided at a front edge of the sliding table 52 so as to enable sliding of the sliding table 52 in the front to rear direction by the operator holding the handle 58.

The support base 22, which is driven in the lateral direction by a bore screw 60 of the second slide mechanism 16, is placed in a vicinity of the rear end of the sliding table 52. The bore screw 60 is rotatably supported by brackets 88 provided at both ends of a laterally extending base plate 86. Guide rails 49, 49, provided with guide grooves 47 similar to the guide grooves 46, are mounted on both lateral sides of the support base 22.

An aligning member 24 including a plate portion 23 and a comb tooth member 64 is arranged on the support base 22. Ridges (not shown) to be guided by the guide grooves 47 are provided on both sides of the plate portion 23 and are arranged to be guided by the guide rails 49. The plate portion 23 and the sliding table 52 are linked so that ends thereof are inseparable in the front to rear direction, while still being capable of sliding laterally with respect to each other. In the present embodiment, the cross-section of the ends is that of connecting members connected to each other. Alternatively, a structure may be adopted utilizing a dovetail and a dovetail groove.

Brackets 62 have arms 62a that extend forward from the front edge of the support base 22. The comb tooth member 64 is held between the arms 62a so that the comb tooth member 64 is rotatable about a shaft 65. Because the comb tooth member 64 is pivotally held by the arms 62a via the shaft 65, the comb tooth member 64 is capable of being placed so as to cover a top of the connector 54 and is capable of being manually rotated upward so as to clear an upper surface of the connector 54 (FIG. 3). Guide slots 68 are provided in the comb tooth member and aligned with insulation displacement slots 66 provided in the connector 54 for connecting the wires 152. In the present embodiment, the comb tooth member 64 is laterally movable with the support base 22 such that the connector 54 and the support base 22 are laterally movable relative to each other.

A wire gripping portion 72 that is independent of the support base 22 is arranged behind the support base 22. The wire gripping portion 72 includes a bracket 74 and an air cylinder 76 mounted on the bracket 74. A rectangular member 80 that has guide rods 78 at both ends thereof is mounted on the bracket 74 so that the rectangular member 80 is slidable in the front to rear direction. A rod 85 that is linked to the air cylinder 76 is mounted on the rectangular member 80 so that the rectangular member 80 slides in the front to rear direction by the operation of the air cylinder 76. An air cylinder 77 is mounted on the rectangular member 80. A chuck 82 for gripping the wires 152 is mounted on the air cylinder 77. The chuck 82 grips a tip of the wire 152 during connection thereof. The application of tension to the wires 152 during connection thereof is accomplished by operating the air cylinder 76 so as to move the chuck 82 backwards with the wire 152 gripped thereby.

A method of discriminating and connecting the wires 152 will now be described in greater detail with reference to FIGS. 3 through 5. As shown in FIG. 3, the sliding table 52 is pulled out by the handle 58 to an extreme forward position. Two connectors 54 are positioned on the connector placement plate 84 that is mounted at the rear end of the sliding table 52, the contacts 55 having already been arranged at predetermined positions in the connectors 54. The aligning member 24, which has been pulled out along with the sliding table 52, is positioned adjacent to the rear of the sliding table 52. The comb tooth member 64 of the aligning member 24 is rotated downward in a direction indicated by an arrow C to cover the top of the connector 54. A multiconductor cable 150 with a plurality of insulated wires 152 is pressed into the cable holding groove 56a to secure the cable 150 within the cable clamp 56. The insulated wires 152 are randomly inserted within the guide slots 68 of the comb tooth member 64 to align the wires 152 in the comb tooth member 64 without considering the corresponding contacts 55. The tips of the wires 152 may be secured by tape or the like such that the wires 152 are arranged at similar intervals as the intervals between the guide slots 68 of the comb tooth member 64. In this 12 case, the tips of the wires 152 are removed after the wires 152 are arranged within the guide slots 68. The other end of the cable 150 has already been connected to another connector (not shown).

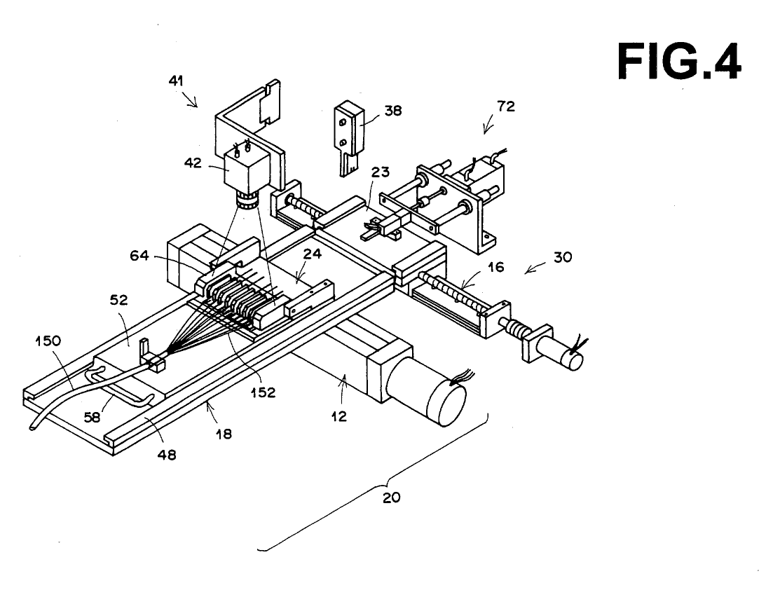

As shown in FIG. 4, the sliding table 52 is pushed to the wire discriminating portion 41, which is located at a substantial center of the guide plate 18, by the handle 58 and is stopped beneath the camera 42. An image is simultaneously obtained of all of the wires 152, which have been aligned. The data obtained from the image is sent to the CPU within the controller 44. The CPU discriminates which of the wires 152 are placed in which of the guide slots 68 based on the colors of the wires 152. The placement of the wires 152 is then compared against a pre-recorded arrangement of the contacts 55 within the connector 54, and the corresponding relationship between the contacts 55 and the wires 152 is determined.

After the wires 152 have been discriminated, the sliding table 52 is pushed further rearward so that the comb tooth member 64 is disposed beneath the stuffer 38 of the connecting portion 39, as shown in FIG. 5. The second stepping motor 14 is driven by a signal from the controller 44 so that a guide slot 68 at one end of the comb tooth member 64 is aligned with the insulation displacement blade 79 of the stuffer 38. In the present embodiment, the leftmost guide slot 68a in FIG. 5 is aligned with the insulation displacement blade 70. The controller 44 drives the first stepping motor 10 so that the contact 55 to which the wire 152 arranged in the guide slot 68 is to be connected to is positioned directly beneath the guide slot 68a. Thereby, the entire guide plate 18, which has the connector 54 placed thereon, is moved toward the left as indicated by arrow E of FIG. 5. The guide plate 18 is stopped at a predetermined position where the wire 152 arranged in the guide slot 68 corresponds to the contact 55 to which the wire 152 is to be connected. The stuffer 38 descends to establish an insulation displacement connection between the wire 152 and the contact 55 corresponding thereto.

During the insulation displacement connection, tension is applied to the insulation displacement portion of the wire 152 the chuck 82. The chuck 82 holds the tip of the wire 152 and moves rearward to apply tension to the wire 152. As a result, the insulation displacement portion of the wire 152 is stretched or straightened to enable appropriate insulation displacement and prevent a deficient connection. If the wires 152 are not straightened and are connected while in a bent state, the portion of the wires 152 from the end of the cable 150 to the connector 54 become balled and difficult to handle. The outward appearance of the wires 152 also suffers decreasing marketability. By applying the tension as described above, these problems are avoided. After the wires 152 have been connected to the contacts 55, the end of the wire 152 which is held by the chuck 82 is severed and discarded.

The second stepping motor 14 is then driven by a signal from the controller 44 to move the support base 22 so that a guide slot 68b, which is adjacent to the guide slot 68a, is aligned with the stuffer 38. The first stepping motor 10 is driven to move the guide plate 18 in either lateral direction so that a contact 55 that corresponds to the wire 152 within the guide slot 68b is positioned directly beneath the guide slot 68b. The second wire 152 is connected with the contact 55 corresponding thereto in a similar manner as the first wire 152.

In this manner, the wires 152 arranged in the comb tooth member 64 are connected to the contacts 55 by sequential movement of the guide slots 68 by a distance of the slot pitch. The appropriate contact 55 for each wire 152 is selected and brought under the wire 152 to which the contact 55 is to be connected by the movement of the guide plate 18. The sequence of operations described above is automatically performed by preset control signals issued by the controller 44. Accordingly, the need to pull the individual wires 152 around during the connection operation is obviated and connections are efficiently established. In addition, because the connections are made one wire 152 at a time, only a small amount of power is required to drive the ram 34. Moreover, as each of the colors and thicknesses of the wires 152 can be discriminated while the insulation displacement blade 70 establishes connections between the wires 152 and the contacts 55 individually, by setting the stroke of the ram 34 in advance, the insulation displacement height can be automatically varied for a plurality of different types of wires 152 that have different diameters. These settings are inputed to the controller 44.

In the embodiment described herein, the first stepping motor 10 and the second stepping motor 14 are controlled so that as the comb tooth member 64 is moved a distance of one slot pitch, the contact 55 corresponding to the wire 152 held therein is positioned thereunder. Other methods, however, are conceivable. For example, the connector 54 may be sequentially moved from the contact 55 at one end thereof to an other end thereof by the contact pitch, and a wire 152 held by the comb tooth member 64 may be moved so that the wire 152 is positioned above the contact 55 that the wire 152 is to be connected to. Alternatively, either the comb tooth member 64 or the connector 54 may be fixed, and the other can be moved along with the stuffer 38 to establish connections between the wires 152 and the contacts 55. In this method, there is no need to pull each of the discriminated wires 152 to the corresponding contact 55 of the connector 54 and extremely efficient connections can be made.

Although the present invention has been described in detail herein, many other embodiments are possible within the scope and spirit of the invention. It goes without saying that various modifications and changes are possible. For example, in the embodiment described in the insulation displacement connecting method, the wire 152 is pressed into the insulation displacement slot of the contact 55 to engage the wire 152 therewith, and the outer covering of the wire 152 is torn by the slot of the contact 55 to electrically contact the core thereof. Alternatively, the present invention may be applied in apparatuses that establish crimp connections. In the case of the crimp connections, a conductive barrel and an insulative barrel of a contact are flexed so as to wrap a core and an outer covering of a wire therein, to obtain fixing of the wire and to electrically conduct therewith. Dedicated stuffers are used for each of the insulation displacement connection and crimp connection. Further, the wires 152 may be of the same color, and have patterns, for example, rings, formed along an outer periphery thereof. In this case, the ring patterns of the wires 152 are discriminated. In addition, combinations of different colors and patterns are also conceivable. It is, therefore, intended that the foregoing description be regarded as illustrative rather than limiting, and that the scope of the invention is given by the appended claims together with their full range of equivalents.

What is claimed is:

1. A wire terminal apparatus, comprising:
a wire aligning portion for randomly arranging wires at a contact arrangement pitch of an electrical connector placed on an adjacent connector placement portion;
a wire discriminating portion that discriminates the wires arranged in the wire aligning portion; and
a control portion that distinguishes which contacts in the electrical connector are to be mated to each of the wires based on discrimination results obtained by the wire discriminating portion, the control portion sequentially aligns the connector placement portion and the wire aligning portion so that the wires discriminated by the wire discriminating portion can be aligned for connection to the contacts corresponding thereto.

2. The wire terminal apparatus of claim 1, wherein the wire discriminating portion discriminates the colors of the wires.

3. The wire terminal apparatus of claim 1, wherein the wire discriminating portion simultaneously obtains an image of all of the wires arranged in the wire aligning portion.

4. The wire terminal apparatus of claim 1, wherein the wire aligning portion includes a comb tooth member with a plurality of guide slots that receive the wires.

5. The wire terminal apparatus of claim 1, wherein the wire aligning portion is positioned proximate a top of the electrical connector.

6. The wire terminal apparatus of claim 1, further comprising a stuffer with an insulation blade that connects the wires to the contacts corresponding thereto.

7. The terminal apparatus of claim 1, further comprising a chuck that grips a tip of the wires to straighten the wires during connection to the contacts.

8. The terminal apparatus of claim 1, further comprising stepper motors that move the connector placement portion and the wire aligning portion.

9. The terminal apparatus of claim 8, wherein the control portion controls the stepper motors such that the wire aligning portion moves one contact arrangement pitch.

10. The terminal apparatus of claim 1, wherein the connector placement portion and the wire aligning portion move laterally to align the wires with the contacts corresponding thereto.
